(19) United States
(12) Patent Application Publication
(10) Pub. No.: US 2014/0356948 A1
(43) Pub. Date: Dec. 4, 2014

(54) Method for Stably Preserving Useful Substances of Cells at Room Temperature

(71) Applicant: Tego Science Inc., Seoul (KR)

(72) Inventors: Saewha Jeon, Seoul (KP); Ki Hoon Lee, Gyeonggi-do (KR); Hankyu Jang, Incheon (KR)

(73) Assignee: TEGO SCIENCE INC., Seoul (KR)

(21) Appl. No.: 14/364,056

(22) PCT Filed: Dec. 10, 2012
(86) PCT No.: PCT/KR2012/010717

§ 371 Date: Jun. 9, 2014

(30) Foreign Application Priority Data
Dec. 9, 2011 (KR) 10-2011-0132135

(51) Int. Cl. A01N 1/02

(52) U.S. Cl. CPC A01N 1/0221
USPC 435/366; 435/374

(57) ABSTRACT

There is provided a method for stably preserving cells and valuable materials included in the cells at room temperature by lyophilizing the cells. When the cells are lyophilized using a lyoprotectant, damage to the structure of the cells which may otherwise occur during a freezing process can be prevented, the lyophilized cells can be stored at room temperature, and the valuable material included in the cells may maintain the functions thereof at room temperature.

### BACKGROUND

The present disclosure relates to a method for stably preserving cells and valuable materials included in the cells at room temperature by lyophilizing the cells.

Lyophilization is a drying method involving freezing a sample in a solution state and removing moisture from the sample through sublimation by keeping the frozen sample under a reduced pressure. This method is widely used to dry samples including water as well as a biological sample.

However, when a sample such as cells containing water is frozen, water molecules are crystallized during freezing while excluding medium like contaminants or solutes. Thus, ice crystals consisting only of water molecules are formed. Therefore, it was known that freeze concentration occurs since the solute in the aqueous material and the medium in the mixture are not diffused uniformly.

The cells may also be damaged when they are stored in a dried state at room temperature.

To solve the above problems, a cryopreservation solution has been used to preserve the cells without causing damage to the structure of the cells upon lyophilization. A cryopreservation solution used in advance to protect the cells before lyophilization includes a buffer solution for maintaining ionic strength and osmotic pressure of a solution, and a lyoprotectant for preventing physical and chemical damage to cells and tissues and changes in structure of the tissues when being frozen and dried. In this case, the lyoprotectant serves to prevent disruption of the tissues caused by recrystallization of ice particles during a lyophilization procedure through an increase in glass transition temperature and enhance stability of the tissues. That is, when the temperature of the tissues while being dried is higher than the glass transition temperature, recrystallization of the ice particles proceeds. In this case, since an increase in size of the recrystallized ice particles causes damage to the tissues, the content of vitreous ice or square ice which is less stable than hexagonal ice and has a small ice crystal size increases in the tissues when a lyoprotectant is used to increase a glass transition temperature, thereby causing less damage to the tissues and an increase in drying rate.

In recent years, generally used lyoprotectants include dimethylsulfoxide (DMSO), dextran, sucrose, glycerol, mannitol, sorbitol, fructose, trehalose, raffinose, serum albumin, and the like, which may be used in combination according to a purpose. These lyoprotectants have been verified for bio-safety, but the mixing conditions satisfying the desired requirements are stringent. Therefore, the lyoprotectants have problems in that a preparation method is complicated and a lot of the manufacturing cost is required.

When bacteria, viruses, serums, vaccines and the like are lyophilized using the lyoprotectant, they can be preserved at room temperature for a long period of time.

However, even when eukaroytic cells are lyophilized using the lyoprotectant, it is difficult to stably preserve the cells without causing damage to the cell structure such as a cell membrane and the like, which makes it difficult to maintain the functions of valuable materials in the cells.

Further, the cells lyophilized using the lyoprotectant should be stored in a freezer or a cold chamber, and the cells and the valuable materials contained in the cells cannot be preserved at room temperature.

### SUMMARY

An aspect of the present disclosure may provide a method for stably preserving cells and valuable materials contained in the cells at room temperature by lyophilizing the cells, and a stable lyophilization preparation prepared by the method.

According to an aspect of the present disclosure, a method for stably preserving lyophilized cells at room temperature may include (1) culturing animal cells, (2) treating the cultured animal cells with a lyoprotectant, and (3) lyophilizing the animal cells treated with the lyoprotectant.

According to another aspect of the present disclosure, a stable lyophilization preparation may be prepared by the method.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a photograph showing the results obtained by observing a sheet shape of keratinocytes derived from a human under an inverted phase contrast microscope;

FIG. 2 is a photograph showing the results obtained by observing a pellet shape of keratinocytes derived from a human under an inverted phase contrast microscope;

FIG. 3 is a photograph showing the results obtained by observing a shape of fibroblasts derived from a human under an inverted phase contrast microscope;

FIG. 4 is a diagram and a photograph showing the sheet shape of keratinocytes attached to a PET film;

FIG. 5 is a diagram and a photograph showing the pellet shape of cells remaining after removal of a supernatant from the cells in a suspension state;

FIG. 6 is a graphical representation showing the results obtained by determining proteins and wound healing factors expressed in the keratinocytes having a sheet shape;

FIG. 7 is a graphical representation showing the results obtained by determining proteins and wound healing factors expressed in the keratinocytes having a pellet shape;

FIG. 8 is a graphical representation showing the results obtained by determining proteins and wound healing factors expressed in the fibroblasts having a pellet shape; and

FIG. 9 is a diagram showing the results obtained by determining a wound healing effect by comparing cells before lyophilization and cells after lyophilization with the control.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

The present disclosure provides a method for stably preserving lyophilized cells at room temperature, which includes (1) culturing animal cells, (2) treating the cultured animal cells with a lyoprotectant, and (3) lyophilizing the animal cells treated with the lyoprotectant.

The term “stably” used herein refers to a condition in which the functions of cells are maintained at room temperature. The room temperature refers to a temperature of 15 to 20° C., and may generally encompasses a cold storage condition (0 to 10° C.) in which the cells are stable.

Cells derived from a mammal or a human may be used as the animal cells according to one exemplary embodiment of the present disclosure.

The cells maybe keratinocytes, or fibroblasts, and the shape of the cells maybe a sheet shape, or a pellet shape. Since the cells having a pellet shape are cells remaining after suspension cells are centrifuged to remove a supernatant, the cells having a pellet shape may include the suspension cells.

A differentiated skin, a skin appendage or embryonic stem cells are suitable for an original tissue of the keratinocytes. When the original tissue is the skin, cells derived from a foreskin, an armpit, a butt, a breast, a scalp, a pubic region, or a scrotum may be used. When the original tissue is the skin appendage, cells derived from a follicle, a sweat gland, a sebaceous gland or a capillary vessel may be suitably used. The follicle maybe derived from the follicles in an anagen stage, and hair whose follicles have keratinocytes attached thereto may be used herein.

The fibroblasts may be obtained by disaggregating tissues of the differentiated skin or differentiating the embryonic stem cells. The disaggregation may be carried out using methods known in the related art. Such methods include physical disaggregation, and/or treatment of a digestive enzyme and/or a chelating agent serving to weaken connection between adjacent cells, and the like. These methods may be used to disperse tissues as single cells without causing damage to the cells. In particular, separation using an enzyme may be easily achieved by mincing tissues, followed by treating the tissues with one of many digestive enzymes or a combination thereof. Examples of proper enzymes may include trypsin, chymotrypsin, collagenase, elastase, hyaluronidase, DNase, pronase and dispase, but the present disclosure is not limited thereto. Physical disaggregation may include methods using a grinder, a blender, a sieve, a homogenizer, or a sonicator, but the present disclosure is not limited thereto.

The cells according to one exemplary embodiment of the present disclosure may grow by culturing cells in a conventional medium for culturing animal cells. Such a medium may be prepared according to components and compositions known in the related art, or commercially available. Media that may be used herein may include a Dulbecco's Modified Eagle's Medium (DMEM); a minimal essential medium (MEM); M199; RPMI 1640; an Iscove's Modified Dulbecco's Medium (EDMEM), MCDB, Ham's F-12, Ham's F-10, NCTC 109, NCTC 135, Keratinocyte-Serum-free medium (keratinocyte-SFM), a keratinocyte growth medium (KGM), and the like, but the present disclosure is not limited thereto.

The medium may further include an antibiotic selected from the group consisting of fetal bovine serum, bovine serum, triiodothyronine (T3), insulin, hydrocortisone, glutamine, adenine, transferrin, gentamycin, andpenicillin-streptomycin, but the present disclosure is not limited thereto.

The animal cells according to one exemplary embodiment of the present disclosure may be treated with a lyoprotectant before lyophilization.

The lyoprotectant according to one exemplary embodiment of the present disclosure may be prepared so that the lyoprotectant can include sugars, proteins, and water-soluble polymer materials.

The sugar that may be used herein may include all of monosaccharides, disaccharides, and polysaccharides, for example, dextrose, maltose, glucose, lactose, sucrose, trehalose, mannose, raffinose, cellobiose, gentiobiose, isomaltose, arabinose, fructose, melezitose, melibiose, sorbitol, and triose, but the present disclosure is not limited thereto.

The sugar according to one exemplary embodiment of the present disclosure serves to protect cell membranes and cell membrane proteins from ice crystals formed during a freezing process and stabilize the cell membranes and the cell membrane proteins. Therefore, it is possible to improve stability of the lyophilization preparation prepared according to the present disclosure and maintain the cell structure without any damage.

The sugar that may be used herein may be properly chosen according to the kinds of cells, and may be included at a content of 0.1 to 20% by weight, based on the total composition of the lyoprotectant. When the content of the sugar is less than 0.1% by weight, effects upon lyophilization may be deteriorated. On the other hand, when the content of the sugar exceeds 20% by weight, the lyoprotectant may not be easily handled due to high viscosity.

Also, the lyoprotectant according to one exemplary embodiment of the present disclosure may include proteins. The protein according to one exemplary embodiment of the present disclosure serves to prevent damage of the cells caused by freezing. Kinds of proper proteins may include albumin, serum, and the like, but the present disclosure is not limited thereto. The protein added to the lyoprotectant may be properly chosen according to the kinds of cells, and the like, and may be included at a content of 1 to 15% by weight, based on the total composition of the lyoprotectant. When the content of the protein is less than 1% by weight, effects upon lyophilization may be deteriorated. On the other hand, when the content of the protein exceeds 15% by weight, an experiment for determining valuable materials contained in the cells may be affected.

Also, the lyoprotectant according to one exemplary embodiment of the present disclosure may include water-soluble polymer materials. The polymer material according to one exemplary embodiment of the present disclosure may serve as a protective agent since the polymer material protects the cells to maintain the constant size and shape during a drying process and improve an ability to endure dryness and storage. Kinds of proper polymer materials may include polyethylene glycol or propylene glycol, hydroxyethyl starch (HES), polyvinyl pyrrolidone, polyacrylamide, polyethylene amine, polyethylene oxide, Ficoll, and the like, but the present disclosure is not limited thereto. The polymer material added to the lyoprotectant may be included at a content of 0.5 to 5% by weight, based on the total composition of the lyoprotectant. When the content of the water-soluble polymer material is less than 0.5% by weight, effects upon lyophilization may be deteriorated. On the other hand, when the content of the water-soluble polymer material exceeds 5% by weight, the lyoprotectant may not be easily handled due to high viscosity.

The treatment of the cells with the lyoprotectant according to one exemplary embodiment of the present disclosure may be performed according to various methods known in the related art. The treatment time may vary according to the kinds of cells, and the like. For example, the cells may be treated at room temperature (15 to 25° C.) for 5 to 10 minutes.

The cells treated with the lyoprotectant according to one exemplary embodiment of the present disclosure may be lyophilized according to lyophilization methods known in the related art using a commercially available lyophilizer. For example, such methods are disclosed in U.S. Pat. No. 4,880,835 issued to Janoff et al.

According to one exemplary embodiment of the present disclosure, the method for lyophilizing the cells may be performed as follows:

(1) putting cells into a proper vessel, floating the cells in a buffer solution, putting the cells into a deep freezer and freezing the cells at a temperature of −15° C. or less for approximately 12 hours or more; (2) cooling a sample chamber of a lyophilizer to −15° C., putting the frozen sample of Operation (1) in the sample chamber and stabilizing the sample for 30 minutes or more; (3) maintaining a temperature of a lyophilizer moisture trap in a range of −70° C. to −80° C., adjusting a vacuum pressure to 10 to 100 mTorr and completely drying the sample by increasing a temperature of the sample chamber of the lyophilizer to a room temperature of 25° C.; and (4) taking the vessel out of the lyophilizer, sealing the vessel with a cap and storing the vessel at room temperature.

Hereinafter, the present disclosure will be described in further detail with reference to Preparative Examples and Experimental Examples. However, it should be understood that detailed description provided herein is merely intended to provide a better understanding of the present disclosure, but is not intended to limit the scope of the present disclosure, as apparent to those skilled in the art.

### EXAMPLE 1

### Culturing Keratinocytes and Fibroblasts Derived from Human

a) Culturing Keratinocytes with Sheet Shape

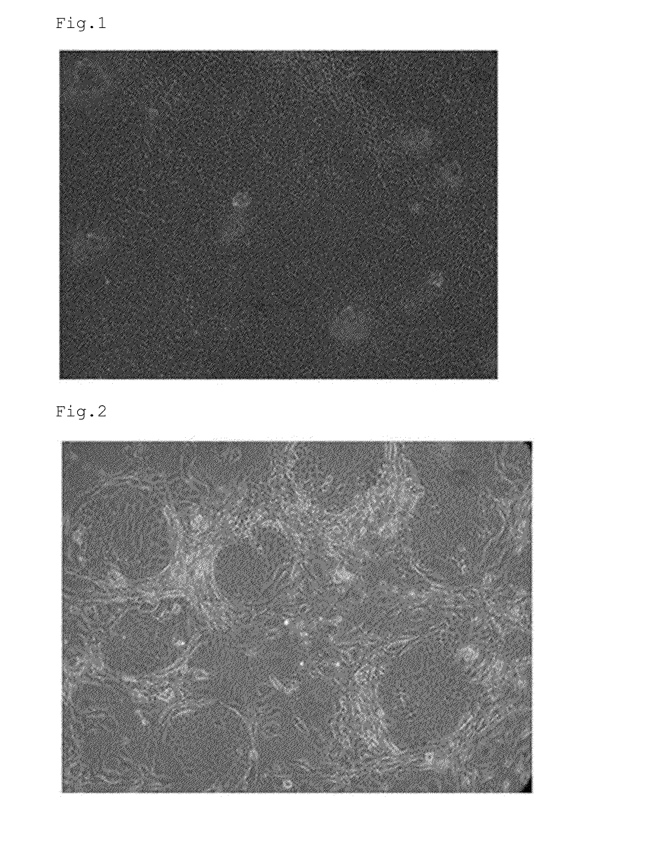

Human-derived keratinocytes were confluently cultured under conditions of 37° C. and 10% CO₂ in a medium prepared by mixing a Dulbecco's modified Eagle medium and Ham-F12 at a mixing ratio of 3:1 in a 3T3 feeder irradiated with gamma rays. The shape of the cells was observed under an inverted phase contrast microscope in a magnification of 100×. As a result, it was revealed that the cells were in a sheet shape as shown in FIG. 1 (see FIG. 1).

b) Culturing Keratinocytes with Pellet Shape

Human-derived keratinocytes were pre-confluently cultured under conditions of 37° C. and 10% CO₂ in a culture broth prepared based on a keratinocyte-serum-free medium. The shape of the cells was observed under an inverted phase contrast microscope in a magnification of 100× (see FIG. 2).

c) Culturing Fibroblast with Pellet Shape

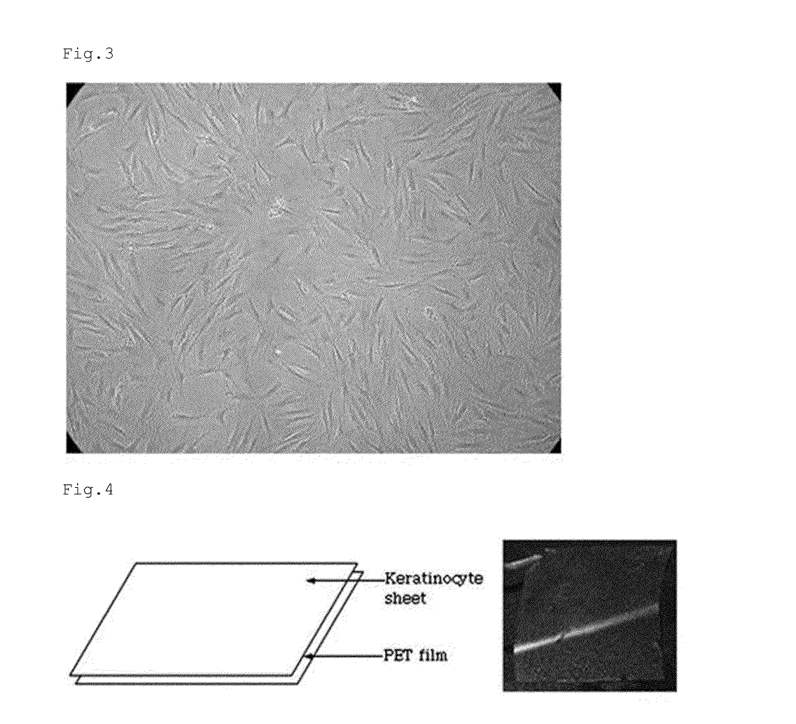

Human-derived fibroblasts were pre-confluently cultured under conditions of 37° C. and 10% CO₂ in a culture broth prepared based on Ham-F12. The shape of the cells was observed under an inverted phase contrast microscope in a magnification of 100× (see FIG. 3).

d) Manufacturing PET Film Coated with Keratinocytes

The keratinocytes having a sheet shape cultured in Operation (a) were attached to a polyethylene terephthalate film (PET film) to be supported thereby (see FIG. 4).

e) Preparing Cells with Pellet Shape from which Supernatant is Removed

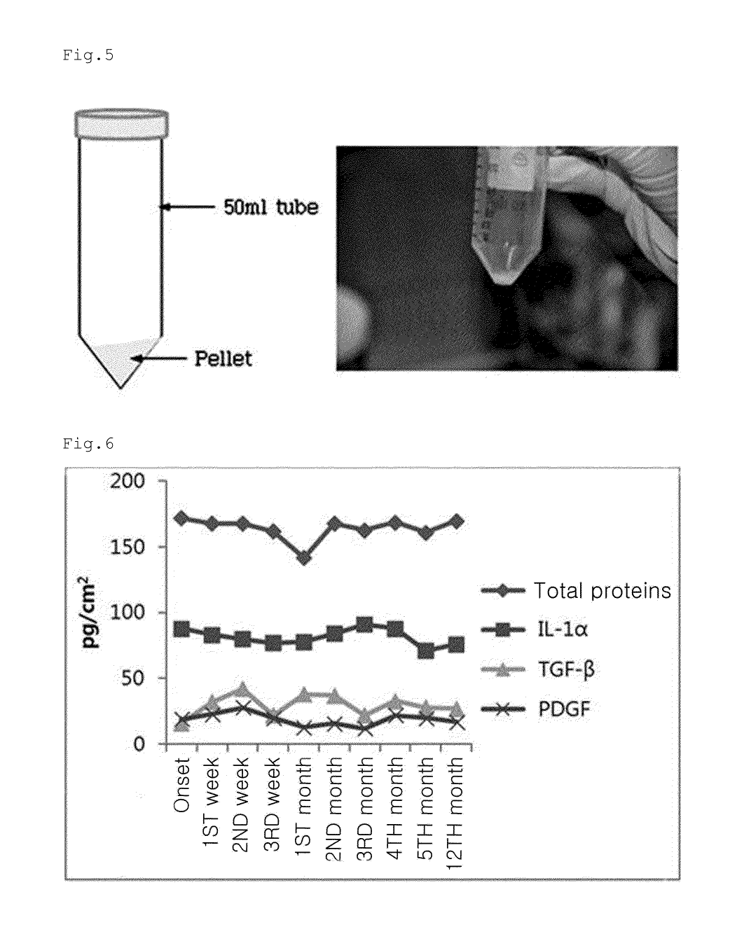

The keratinocytes and fibroblasts pre-confluently cultured in Operations (b) and (c) were centrifuged to collect a cell pellet, and the supernatant was discarded (see FIG. 5).

### EXAMPLE 2

### Preparation of Lyoprotectant and Treatment Method

A polymer material, polyethylene glycol (PEG having a molecular weight of 6,000 to 35,000), was added at a concentration of 0.5 to 5% by weight to a cryopreservation solution, which was prepared by adding saccharides, for example, 0.1 to 5% by weight—of glucose, 0.1 to 5% by weight—of sucrose, 0.1 to 5% by weight—of dextran and 0.1 to 5% by weight—of raffinose, 0.1 to 5% by weight—of albumin, and 1 to 10% by weight—of serum to a DMEM medium, to prepare a lyophilized preservative solution.

The cells having a sheet shape were prepared by discarding the culture broth, adding a DMEM medium to the cells so that the cells were almost immersed in the medium, washing out the remaining culture broth, adding a lyophilized preservative solution to the cells so that the cells were immersed in the solution, and treating the cells for 5 to 10 minutes. The cells having a pellet shape were prepared by adding 40 mL of PBS to a pellet contained in a 50 mL tube, pipetting the pellet, and centrifuging the pellet suspension to wash out the remaining culture broth. After this procedure was performed three times, a lyophilized preservative solution was added to the pellet remaining in the 50 mL tube so that the pellet was almost immersed in the solution, pipetted, treated for 5 to 10 minutes, and centrifuged to remove a supernatant.

### EXAMPLE 3

### Lyophilization of Keratinocytes and Fibroblasts

The cells treated with the lyophilized preservative solution in Example 2 were frozen at a temperature of −15° C. or less for 12 hours or more. The cells having a sheet shape were dried at an increasing temperature from −15° C. to room temperature (i.e., 25° C.) for 30 to 90 minutes. The temperature of a moisture trap was maintained at −70° C. to −80° C., and the vacuum pressure was maintained at 10 to 100 mTorr. After drying, the cells were sealed, and stored at room temperature. The cells having a pellet shape were dried at an increasing temperature from −15° C. to room temperature (i.e., 25° C.) for 6 hours or more. The temperature of the moisture trap was maintained at −70° C. to −80° C., and the vacuum pressure was maintained at 10 to 100 mTorr. The completely dried cells were sealed and stored at room temperature.

### EXPERIMENTAL EXAMPLE 1

### Rate of Removal of Moisture from Lyophilized Cells

The cells were weighed before and after lyophilization to calculate a ratio of moisture removed after the lyophilization. Both of the cells having a sheet shape and a pellet shape exhibited a rate of moisture removal of 98% or more when lyophilized using the method described in Example 3.

### EXPERIMENTAL EXAMPLE 2

### Measurement of Stability of Cells Before and After Lyophilization

The cells having a pellet shape and the cells have a sheet shape were lyophilized to measure stabilities of major factors. The cells were stored at room temperature, and measured at the onset, 1^{st} week, 2^{nd} week, 3^{rd} week, 1^{st} to 5^{th} month and 12^{th} month. In the case of the keratinocytes, the total amount of proteins and the contents of IL-α, b-FGF, TGF-β, and PDGF were measured. In the case of the fibroblasts, the contents of b-FGF, TGF-β, and PDGF were measured using the following method.

Four ml of PBS was added to the lyophilized cells having a sheet shape so that the cells were immersed in PBS, and 4 ml of PBS was added to the lyophilized cells having a pellet shape, and the lyophilized cells were hydrated through pipetting. Thereafter, the total proteins were stained with a staining dye, and optical density was measured using ELISA. Also, IL-α, b-FGF, TGF-β, and PDBF were measured using a Quantikine Immunoassay kit (R&D System).

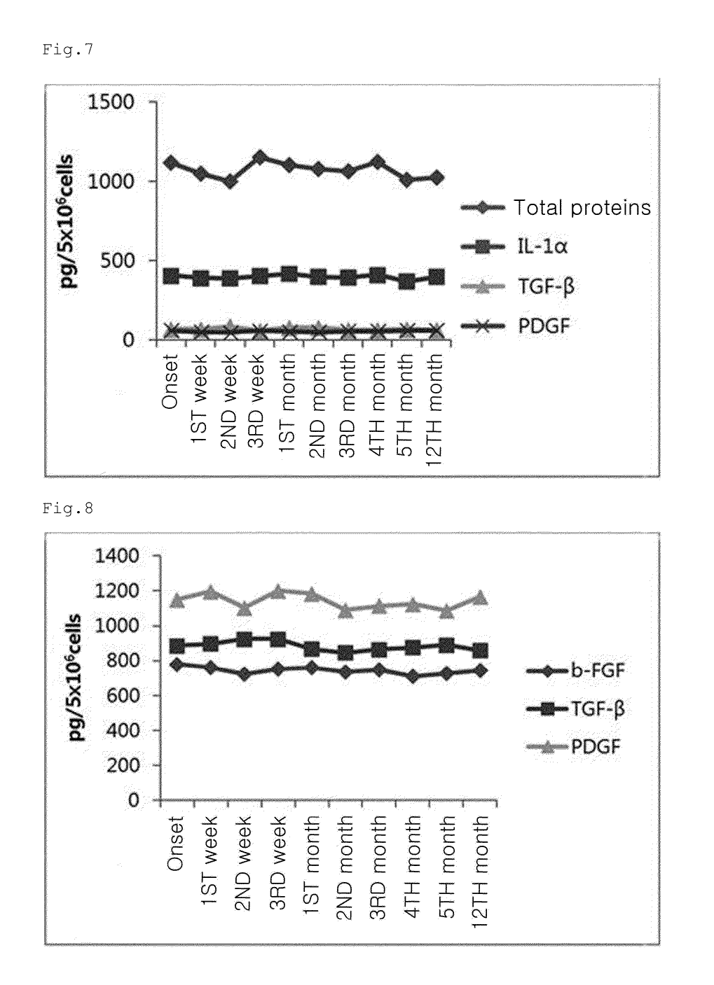

From the measurement results, it was revealed that the respective factors were stably maintained regardless of the kinds and shapes of the cells (see FIGS. 6, 7 and 8).

### EXPERIMENTAL EXAMPLE 3

### Measurement of Wound Healing Effect of Lyophilizes Cells

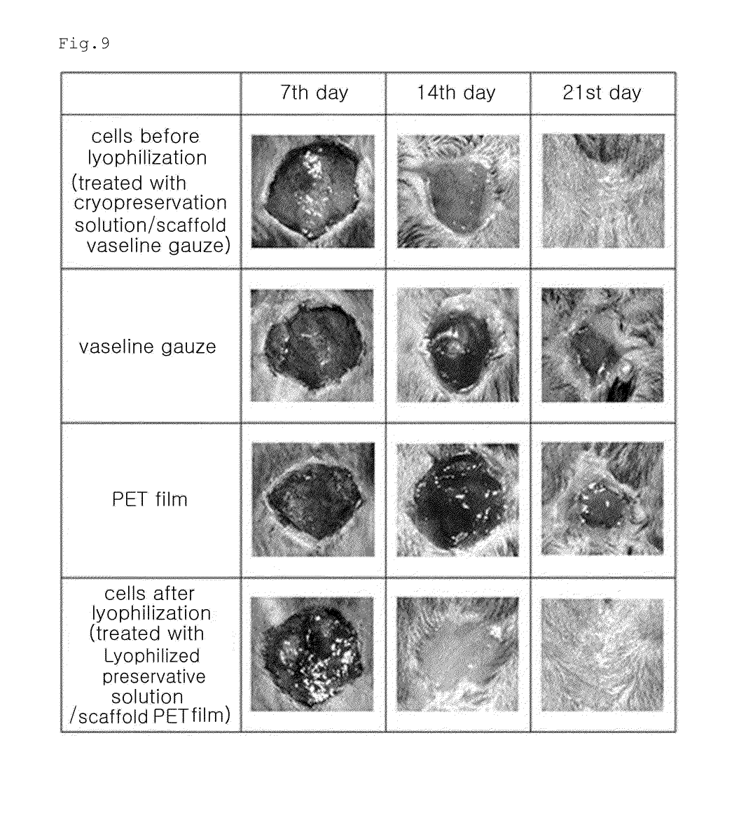

Four wounds having a diameter of 1.5 cm were made at the back of a mouse (Balb/c). Thereafter, in an experimental group, 1) the cells before lyophilization which were treated with a cryopreservation solution and then supported with a vaseline gauze, and 2) the cells after lyophilization which were treated with a lyophilized preservative solution and then supported with a PET film were applied to the mouse. In the control, 1) a vaseline gauze and 2) a PET film were applied to the mouse. Then, a wound healing effect was measured at 7^{th}, 10^{th}, 14^{th} and 21^{st} days. From the measurement results, it was revealed that all the groups of cells before and after lyophilization exhibited a higher wound healing effect than the control, as shown in FIG. 9.

### INDUSTRIAL APPLICABILITY

When the cells are lyophilized using the lyoprotectant according to one exemplary embodiment of the present disclosure, the damage of the cell structure which may be caused during a freezing process can be prevented, and the valuable materials contained in the cells can maintain the functions thereof at room temperature.

Also, when the cells are lyophilized using the lyoprotectant according to one exemplary embodiment of the present disclosure, the damage to the cell structure which may be caused during a freezing process can be prevented, the lyophilized cells can be stored at room temperature for one year or more, and the valuable materials contained in the cells can maintain the functions thereof at room temperature.

While exemplary embodiments have been shown and described above, it will be apparent to those skilled in the art that modifications and variations could be made without departing from the spirit and scope of the present disclosure as defined by the appended claims.

What is claimed is:

1. A method for stably preserving lyophilized cells at room temperature, comprising:
(1) culturing animal cells;
(2) treating the cultured animal cells with a lyoprotectant; and
(3) lyophilizing the animal cells treated with the lyoprotectant.

2. The method of claim 1, wherein the animal cells are cells derived from a human.

3. The method of claim 2, wherein the cells are keratinocytes, or fibroblasts.

4. The method of claim 1, wherein the lyoprotectant comprises sugars, proteins, and water-soluble polymer materials.

5. The method of claim 4, wherein the sugar is selected from the group consisting of dextrose, maltose, glucose, lactose, sucrose, trehalose, mannose, raffinose, cellobiose, gentiobiose, isomaltose, arabinose, fructose, melezitose, melibiose, sorbitol, and triose.

6. The method of claim 4, wherein the protein is albumin, or serum.

7. The method of claim 4, wherein the water-soluble polymer material is selected from the group consisting of polyethylene glycol or propylene glycol, hydroxyethyl starch (HES), polyvinyl pyrrolidone, polyacrylamide, polyethylene amine, polyethylene oxide, and Ficoll.

8. A stable lyophilization preparation prepared by the method defined in any one of claims 1 to 7.
